(19) United States
(12) Patent Application Publication
(10) Pub. No.: US 2004/0100908 A1
(43) Pub. Date: May 27, 2004

(54) Method and apparatus to provide IP QoS in a router having a non-monolithic design

(76) Inventors: Hormuzd M. Khosravi, Hillsboro, OR (US); Sanjay Bakshi, Beaverton, OR (US)

Correspondence Address: Vani Moodley, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/306,233

(22) Filed: Nov. 27, 2002

(51) Int. Cl. H04J 1/16; H04J 3/16

(52) U.S. Cl. 370/235; 370/465

(57) ABSTRACT

A method and system comprising classifying packets flowing into a first blade of a router; associating a marker entry with each of the packets based on the classification, the marker entry determining how the packets will be processed by QoS blocks within the first blade; and providing a processing block on a second blade of the router to determine how to process each packet within the second blade based on its marker entry.

### FIELD OF THE INVENTION

This invention relates to routers in networks. In particular, it relates to the implementation of quality of service (QoS) protocols in these routers.

### BACKGROUND

Network elements such as layer 3 switches and IP routers can be classified into three logical components; viz., a control plane, a forwarding plane, and a management plane. The control plane controls and configures the forwarding plane, whereas the forwarding plane manipulates network traffic. In general, the control plane executes various signaling or routing protocols e.g., the Routing Information Protocol (RIP), and the Open Shortest Path First (OSPF) and provides control information to the forwarding plane. The forwarding plane makes decisions based on this control information and performs operations on packets such as forwarding, classification, filtering, etc. The management plane manages the control and forwarding planes and provides capabilities such as logging, diagnostic, non-automated configuration, etc.

IP Quality of Service (IP QoS) refers to the level of services, e.g. prioritized treatment, scheduling, etc. that packets belonging to an IP flow receive as they traverse through a network. IP QoS is characterized by a small set of metrics, including service availability, delay, delay variation (jitter), throughput, and packet loss rate.

DiffServ is an Internet Engineering Task Force (IETF) standard for implementing IP QoS. With DiffServ, flows are classified according to predetermined rules such that flows may be given a particular QoS treatment based on their classification.

There is a growing trend away from vertical or monolithic and proprietary switch and router architectures where all the components are provided by a single manufacturer. The current trend is towards non-monolithic switches and routers with a clear standards based separation between the control and forwarding planes. By the use of standardized application program interfaces (APIs) and protocols between the control and forwarding planes, it is possible to mix and match components from different vendors to build a router leading to shorter time to market for these devices.

In this regard work is happening in two public bodies to provide standardized and open interfaces between control and forwarding plane. The Network Processing Forum (NPF) has defined industry standard APIs for this purpose which present a flexible and well known programming interface to all control plane applications. Typically a forwarding plane consists of multiple forwarding elements (FE) or line-cards. The NPF APIs make the existence of multiple FEs as well their vendor-specific details transparent to control plane applications. Thus, the protocol stacks and FEs available from different vendors can be easily integrated using the NPF APIs. Similarly at IETF, ForCes working group is defining the protocol needed between control and forwarding plane.

Intel provides a Control Plane Platform Development Kit (CP PDK) which is a reference implementation of the NPF APIs and supports forwarding plane consisting of FEs based on Intel's network processors. The CP PDK architecture also provides a reference implementation of the experimental ForCes protocol between the control and forwarding planes. While CP PDK's architecture provides many advantages over monolithic proprietary designs, it also introduces new challenges in preserving the behavior of a standard networking device. One such issue is how to provision IP QoS for packets flowing through a set of FEs which are part of a single router or switch. Moreover, considering that a forwarding plane can have FEs from different vendors make the problem important to solve. For example, in a single router with DiffServ support, packets are given certain QoS treatments in the forwarding plane. For a network element in which the packets may be forwarded across multiple FEs from different vendors before they leave the router, it is important to preserve the QoS behavior of a traditional old monolithic and proprietary router.

### BRIEF DESCRIPTION OF THE DRAWINGS

FIG. 1 shows a high level block diagram of a router or switch architecture based on the CP PDK architecture;

FIG. 2 shows a block diagram of the functional components within an ingress forwarding element and an egress forwarding element of the router/switch of FIG. 1.

FIGS. 3 and 4 show flowcharts of operations performed by the control element of the router of FIG. 1, in accordance with this embodiment; and

FIG. 5 shows a high level block diagram of the components within the control plane of the switch/router of FIG. 1.

### DETAILED DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram format in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

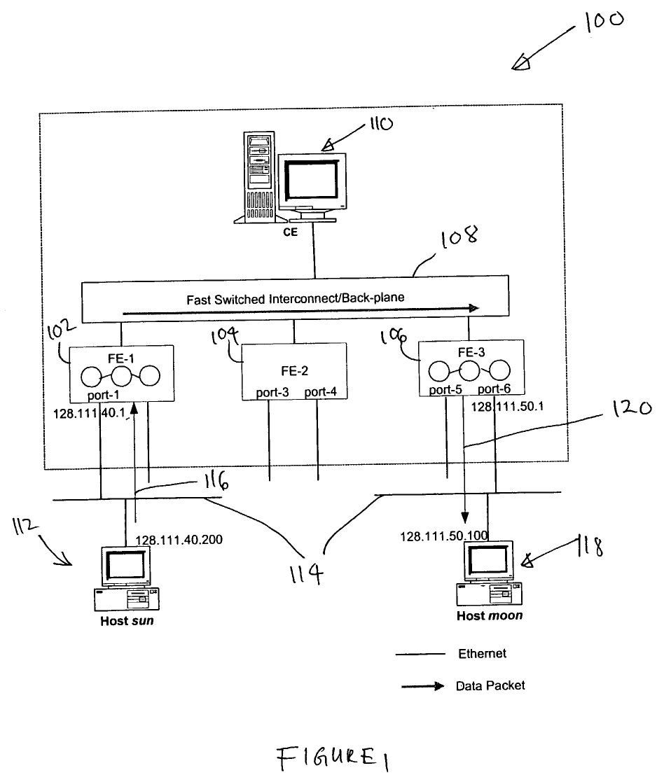

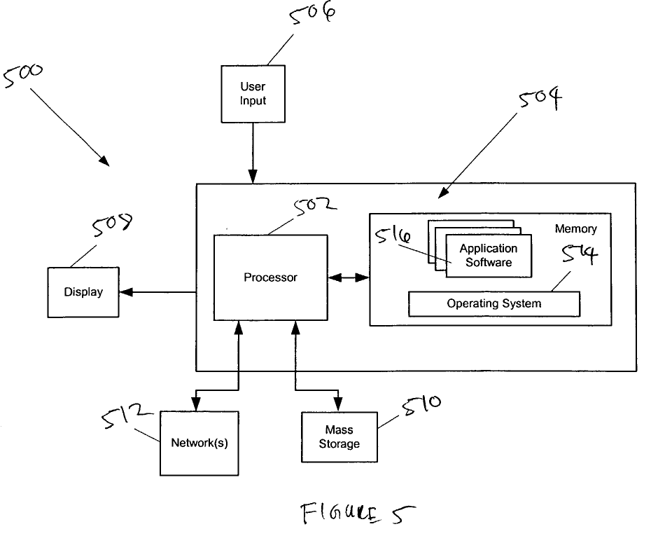

FIG. 1 of the drawings shows a high level block diagram of a router/switch 100 based on the CP PDK architecture. The router/switch 100 provides support for inter-FE QoS or QoS to packets that traverse more than one FE before exiting the router/switch 100. Referring to FIG. 1, it will be seen that the switch/router 100 includes three FEs indicated by reference numerals 102, 104 and 106, respectively. The FEs 102-106 are connected by an interconnect or back plane fabric 108 as shown. The interconnect or back plane fabric 108 may be a fast switched interconnect or a high speed bus, in some embodiments. In order to control the FEs 102-106, the router/switch 100 includes a control plane or simply control element (CE)110, which in some embodiments includes a general purpose computer programmed to control the FEs 102-106. A high level block diagram of the functional components of the control element 110 is provided in FIG. 5 of the drawings.

Although the switch/router 100 is shown to include only three forwarding elements 102-106, it will be appreciated that in other embodiments, there may be more than three forwarding elements, or even less than three forwarding elements.

For the purposes of this description, forwarding element 102 is an ingress forwarding element and receives data packets from a node 112 within a network. The node 112 and the switch/router 100 may be connected, for example, via an Ethernet cable 114. Packet flow from the node 112 to the forwarding element 102 is indicated by arrow 116.

The forwarding element 102 receives the data packets from the node 112, processes the data packets and forwards them via the interconnect/back plane 108 to an egress forwarding element, which for the purposes of this description is the forwarding element 106. The forwarding element 106 receives the data packets and further processes them before sending them to their destination node 118. A destination node 118 and the switch/router 100 may be connected, for example, via an Ethernet cable 114, in accordance with one embodiment. Packet flow from the node 106 to the node 118 is indicated by arrow 120.

As described above, the router/switch 100 supports inter-FE IP QoS. Thus, each of the forwarding elements 102-106 includes QoS processing blocks to apply a QoS treatment to data packets.

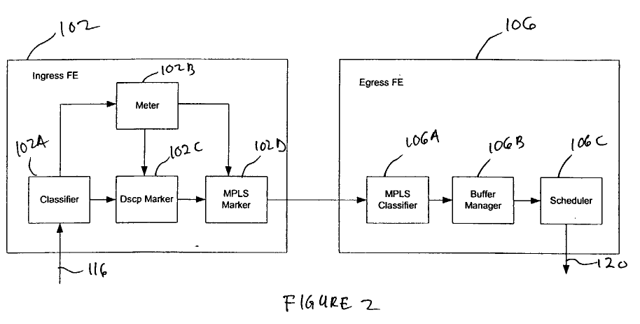

Referring now to FIG. 2 of the drawings, a high level functional block diagram of forwarding elements 102 and 106 is shown, wherein the QoS processing blocks can be seen. As with FIG. 1 of the drawings, packet flow into the ingress forwarding element 102 is indicated by arrow 116 and packet flow out of the egress forwarding element 106 is indicated by arrow 120. The packets flowing into the ingress forwarding element 102 are first classified by a classifier 102A as per some pre-configured profiles or filters. In one embodiment, the classifier 102A may be a five tuple classifier which classifies incoming data packets in accordance with filters that specify source IP address, destination IP address, source port, destination port, and IP protocol type.

Data packets that satisfy a particular classification criterion define a data flow. The ingress forwarding element 102 also includes a meter 102B to meter the incoming data packets. The meter 102B meters the data packets as conforming or non-conforming to a certain criterion or profile. For example, the meter 102B may meter the incoming data packets as conforming to a certain packet flow rate or non-conforming to the packet flow rate. This allows different QoS treatment for conforming and non-conforming data packets. In one embodiment, the ingress forwarding element 102 also includes a DiffServ Code Point (DSCP) marker 102C to insert a DiffServ Code Point into the data packet so that other routers within that network can use the DSCP to further classify and process the data packet. In order to implement IP QoS within the ingress forwarding element 102, the classifier 102A associates certain metadata to each classified data packet so that other components (QoS Blocks) within the forwarding element 102 can apply a QoS treatment to the data packets based on the metadata. One example of the metadata includes a flow identifier which is appended to the packets. The flow identifier is an unsigned integer which is used to identify packets that match a particular filter in a classifier such as 102A.

The switch/router 100 is set up so that packets that match a particular filter are given a particular IP QoS treatment within the forwarding element 102. Each QoS block uses the metadata (flow identifier, etc) to provide treatment to a packet. In order to configure QoS blocks spanning multiple FEs, the metadata should be carried across multiple forwarding elements. In order to achieve the transport of the metadata to multiple forwarding elements, in accordance with one embodiment of the present invention, the ingress forwarding element 102 includes a marker processing block 102D. The marker processing block 102D marks each data packet with a marker entry or identifier based on the metadata associated with the packet.

In one embodiment, the marker entry may be any label or tag and is appended to each data packet. Advantageously, the marker entry may be a standards-based marker entry such as a Multi-Protocol Label Switching (MPLS) label. After being marked by the marker processing block 102D, each data packet is forwarded to the egress forwarding element 106. The egress forwarding element 106 includes a classifier 106A to classify each incoming data packet based on its marker entry or identifier. The classifier 106A includes an entry installed therein to recover the metadata for the packet based on its identifier/marker entry. In one embodiment, the classifier 106A is an MPLS classifier. The egress forwarding element 106 further includes a buffer manager 106B and a scheduler 106C which perform buffering and scheduling functions, respectively, based on the metadata associated with each data packet.

It will be appreciated that by marking each incoming data packet with a identifier/marker entry based on the metadata for the packet in an ingress forwarding element and thereafter using a classifier to recover the metadata for each packet based on its identifier/marker entry within an egress FE, it is possible to implement IP QoS across multiple FEs. Further, by using a standards-based marker entry to mark each data packet, the multiple forwarding elements within a router/switch may be from different manufacturers, and it will still be possible to transport or carry the metadata information associated with each data packet across the multiple FEs since each forwarding element, although manufactured by a different manufacturer, would provide support for a standards-based marker entry. Thus, one advantage of the present invention is that it allows for the construction of a router/switch using forwarding elements from different vendors while at the same time providing a mechanism for implementing IP QoS for flows traversing multiple across the different blades/forwarding elements.

It will be appreciated that the identifier/marker entry assigned to each data packet by the marker processing block 102D may also be used by a back plane bandwidth manager to configure any QoS/scheduling parameters for data flows across the back plane interconnect 108.

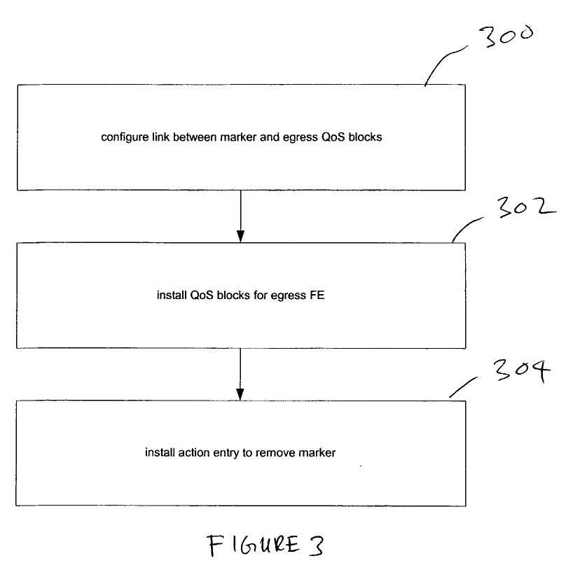

Control of the marker processing block 102D and the classifier 106A is provided by control element 110. FIG. 3 of the drawings shows a flowchart of operations performed by the control element 110 in controlling the egress forwarding element 106. Referring to FIG. 3 at block 300, the control element 110 configures an association between the marker entry assigned to each data packet in the marker and the corresponding metadata used by the egress processing blocks 106B and 106C. For example, operations performed at block 300 include installing a label/classification entry in the classifier 106A which maps each label to metadata for the label. An example of metadata includes a flow identifier (ID) associated with a particular flow as classified by the classifier 102A. At block 302, the control element 110 configures QoS blocks for the egress FE in order to provision QoS treatments for the data flows. At block 304, the control element 110 installs an action entry in the classifier 106A to remove the marker entry or label from each data packet before it is forwarded to a further node by the egress forwarding element 106.

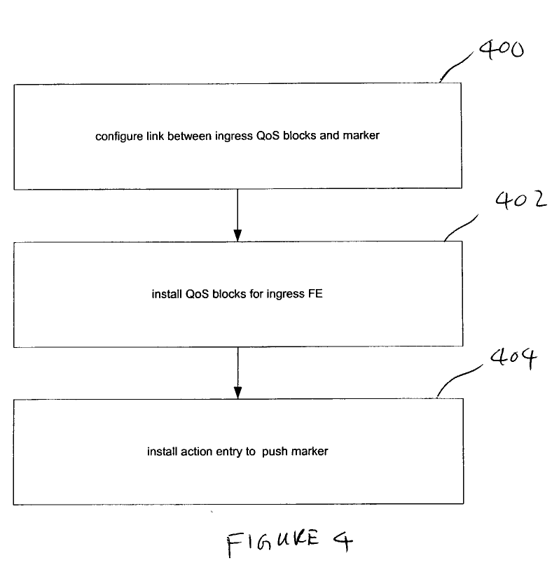

FIG. 4 shows a flowchart of operations performed by the control element 110 in controlling the ingress forwarding element 102. Referring to FIG. 4 at block 400, the control element 110 configures an association between the ingress processing blocks and each marker entry to be assigned to each classified data packet based on its metadata. Thus, in one embodiment, operations at block 400 include assigning a label for a particular flow ID to the data packets with that flow ID. At block 402, the particular QoS blocks for the ingress forwarding element 102 are installed. At block 404, an entry is installed in the marker processing unit 102D to push a marker entry or label onto each data packet based on its metadata.

In one embodiment, the control element 110 installs the QoS blocks on the egress forwarding element 106 before it installs entries on the ingress forwarding element 102. This is to prevent any packets from being dropped by the ingress forwarding element during the installation time lag between the ingress and egress.

The classifier 106A implements a switch-label table which is used to recover or find the metadata associated with a particular label. Look ups into the switch-label table is based on an exact label match instead of on a longest prefix match, which is used in the case of a router/classifier table look up. In some embodiments, the switch-table may be in the form of a hash table, in which case searching the table takes O (1) time instead of O (n) time taken to search the router/classifier table (n is a number of entries in the table).

Referring to FIG. 5 of the drawings, reference numeral 500 generally indicates hardware that may be used to implement the control element 110. The hardware 500 typically includes at least one processor 502 coupled to a memory 504. The processor 502 may represent one or more processors (e.g. microprocessors), and the memory 504 may represent random access memory (RAM) devices comprising a main storage of the hardware 500, as well as any supplemental levels of memory e.g., cache memories, non-volatile or back-up memories (e.g. programmable or flash memories), read-only memories, etc. In addition, the memory 504 may be considered to include memory storage physically located elsewhere in the hardware 500, e.g. any cache memory in the processor 502, as well as any storage capacity used as a virtual memory, e.g., as stored on a mass storage device 510.

The hardware 500 also typically receives a number of inputs and outputs for communicating information externally. For interface with a user or operator, the hardware 500 may include one or more user input devices 506 (e.g., a keyboard, a mouse, etc.) and a display 508 (e.g., a CRT monitor, a LCD panel).

For additional storage, the hardware 500 may also include one or more mass storage devices 510, e.g., a floppy or other removable disk drive, a hard disk drive, a Direct Access Storage Device (DASD), an optical drive (e.g. a CD drive, a DVD drive, etc.) and/or a tape drive, among others. Furthermore, the hardware 500 may include an interface with one or more networks 512 (e.g., a land, a WAN, a wireless network, and/or the Internet among others) to permit the communication of information with other computers coupled to the networks. It should be appreciated that the hardware 500 typically includes suitable analog and/or digital interfaces between the processor 502 and each of the components 504, 506, 508 and 512 as is well known in the art.

The hardware 500 operates under the control of an operating system 514, and executes various computer software applications, components, programs, objects, modules, etc. (e.g. a program or module which performs operations as shown in FIGS. 4 and 5 of the drawings). Moreover, various applications, components, programs, objects, etc. may also execute on one or more processors in another computer coupled to the hardware 500 via a network 512, e.g. in a distributed computing environment, whereby the processing required to implement the functions of a computer program may be allocated to multiple computers over a network.

In general, the routines executed to implement the embodiments of the invention, may be implemented as part of an operating system or a specific application, component, program, object, module or sequence of instructions referred to as “computer programs”. The computer programs typically comprise one or more instructions set at various times in various memory and storage devices in a computer, and that, when read and executed by one or more processors in a computer, cause the computer to perform these steps necessary to execute steps or elements involving the various aspects of the invention. Moreover, while the invention has been described in the context of fully functioning computers and computer systems, those skilled in the art will appreciate that the various embodiments of the invention are capable of being distributed as a program product in a variety of form, and that the invention applies equally regardless of the particular type of signal bearing media used to actually off the distribution. Examples of signal bearing media include but are not limited to recordable type media such as volatile and non-volatile memory devices, floppy and other removable disks, hard disk drives, optical disks (e.g. CD ROMS, DVDs, etc.), among others, and transmission type media such as digital and analog communication links.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

What is claimed is:

1. A method, comprising:
classifying packets flowing into a first blade of a router;
associating a marker entry with each of the packets based on the classification, the marker determining how the packets will be processed by QoS blocks within the first blade; and
providing a processing block on a second blade of the router to determine how to process each packet within the second blade based on its marker entry.

2. The method of claim 1, wherein the first and second blades support different protocols.

3. The method of claim 1, wherein the first and second blades are made by different manufacturers.

4. The method of claim 1, wherein the marker entry is a standards based marker entry.

5. The method of claim 4, wherein the marker entry is a MPLS label.

6. The method of claim 1, wherein the processing block comprises an MPLS classifier.

7. A method, comprising:
assigning an identifier for packets that meet a classification criterion;
installing an entry in a first blade to cause packets that meet the classification criterion to be marked with the identifier; and
installing an entry in a second blade to recover a classification of each packet entering the second blade from the first blade based on the classifier.

8. The method of claim 7, wherein the assigning is based on input specifying the classification criterion and a QoS treatment for packets that meet the classification criterion.

9. The method of claim 7, wherein installing the entry in the second blade is performed before installing the entry in the first blade.

10. The method of claim 7, wherein the first blade is an ingress blade and the second blade is an egress blade of a non-monolithic packet router.

11. The method of claim 7, wherein the first and second blades support different protocols.

12. The method of claim 7, wherein the identifier is a standardized identifier.

13. The method of claim 12, wherein the identifier is an MPLS identifier.

14. A computer-readable medium having stored thereon a sequence of instructions, which when executed by a computer cause the computer to perform a method comprising:
assigning an identifier for packets that meet a classification criterion;
installing an entry in a first blade to cause packets that meet the classification criterion to be marked with the identifier; and
installing an entry in a second blade to recover a classification of each packet entering the second blade from the first blade based on the identifier.

15. The computer-readable medium of claim 14, wherein the assigning is based on input specifying the classification criteria and a QoS treatment for packets that meet the classification criterion.

16. The computer-readable medium of claim 14, wherein installing the entry in the second blade is performed before installing the entry in the first blade.

17. The computer-readable medium of claim 14, wherein the first blade is an ingress blade and the second blade is an egress blade of a non-monolithic packet router.

18. A system, comprising:
an ingress forwarding element to receive incoming data packets; and
at least one egress forwarding element to forward the incoming data packets to a node in a network, wherein the ingress forwarding element comprises a marker unit entry to apply a marker to packets of a particular classification; and the or each egress forwarding element has a corresponding marker unit to determine the classification of a packet based on the marker entry.

19. The system of claim 18, wherein the marker unit applies a standardized marker entry to the packets.

20. The system of claim 18, wherein the marker unit comprises an MPLS marker unit.

21. A system, comprising:
a processor; and
a memory coupled to the processor, the memory storing instructions which when executed by the processor cause the processor to perform a method comprising:
assigning an identifier for packets that meet a classification criterion;
installing an entry in a first blade to cause packets that meet the classification criterion to be marked with the identifier; and
installing an entry in a second blade to recover a classification of each packet entering the second blade from the first blade based on the identifier.

22. The system of claim 21, wherein the assigning is based on input specifying the classification criterion and a QoS treatment for packets that meet the classification criterion.
